(19) United States
(12) Patent Application Publication
(10) Pub. No.: US 2006/0039944 A1
(43) Pub. Date: Feb. 23, 2006

(54) Solid polymeric dispersant composition for water-insoluble actives

(75) Inventors: Kolazi S. Narayanan, Wayne, NJ (US); Jayanti Patel, Elmwood Park, NJ (US); Paul Taylor, Parsippany, NJ (US); Domingo Jon, New York, NY (US)

Correspondence Address: INTERNATIONAL SPECIALTY PRODUCTS;Attn: William J. Davis , Esq., Legal Department, 1361 Alps Road, Building No. 8, Wayne, NJ, 07470, US

(73) Assignee: ISP INVESTMENTS INC.

(21) Appl. No.: 10/920,061

(22) Filed: Aug. 17, 2004

(51) Int. Cl. A01N 25/34

(52) U.S. Cl. 424/408

(57) ABSTRACT

A solid polymeric dispersant composition for water-insoluble actives includes a primary anionic polymer dispersing agent and a co-dispersant which is a vinyl lactam, in a defined weight ratio, and wettable powders, water dispersible granules and tablets thereof, for delivery of actives to a desired site.

### CROSS-REFERENCE TO RELATED PATENT AND PATENT APPLICATIONS

This application is related to U.S. Pat. No. 6,156,803 which disclosed the use of a partially neutralized alkyl vinyl ether-maleic acid half ester copolymer as a dispersing agent for water-insoluble agriculturally active chemicals; and to U.S. patent application, Ser. No. 10/209,122, filed Jul. 31, 2002, which described an aqueous suspension concentrate for water insoluble chemicals comprising a mixture of an anionic polymeric suspension agent and a homo- and/or a co-polymer of a heterocyclic vinyl lactam.

### BACKGROUND OF THE INVENTION

1. Field of the Invention

This invention relates to delivery systems for water-insoluble active chemicals such as agriculturally active compounds and pharmaceuticals, and, more particularly, to a synergistic solid polymeric dispersant composition including one or more, anionic polymeric dispersants, and a homo- and/or a co-polymer of a heterocyclic vinyl lactam. Wettable powders, water dispersible granules and tablets, of the solid composition, for delivering of such actives, also are described herein.

2. Description of the Prior Art

Numerous delivery systems and formulations have been proposed to provide aqueous solutions of substantially water insoluble agriculturally active chemicals. Such compositions include those disclosed in U.S. Pat. Nos. 5,300,529; 5,283,229; 5,250,499; 5,176,736; 5,160,528; 5,156,666 and 5,071,463. These patents involve solubilization of the water insoluble active component with suitable non-polymeric lactams. In the field, however, it is desirable that the active component retain its hydrophobic character both in the concentrate and diluent compositions so as to extend its activity on the plant under climatic conditions such as rainfall and provide systemic effects. Additionally, many of the prior formulations limit the load of the active compound in order to achieve stability, or have been found to provide only ephemeral suspensibility. Still further, many of the suspension agents presently in use are specific to a limited group of active compounds.

However, these compositions are not particularly suitable to formulate water-sensitive active ingredients, or to prepare compositions under anhydrous conditions like roller compaction using dry components.

Accordingly, it is an object of this invention to provide a synergistic, solid polymeric dispersant composition for water-insoluble actives, including water-sensitive actives, wherein the solid form is particularly useful for delivery of the active in the form of wettable powders, water dispersible granules, tablets and use formulations thereof.

### SUMMARY OF THE INVENTION

What is described herein is a solid polymeric dispersant composition including one or more anionic polymeric dispersant agents and a co-dispersant which is a homopolymer and/or a copolymer of a heterocyclic vinyl lactam containing 4 to 6 ring carbon atoms; which heterocyclic polymer is optionally substituted on the ring or in the vinyl moiety with lower alkyl, in a wt. ratio of 0.1:1 to 1:0.1, respectively, preferably 1:0.5 to 1:5; and most preferably 1:1 to 1:4.

Preferably the vinyl lactam polymer is a homo- or co- polymer of N-vinyl pyrrolidone and N-vinyl caprolactam, and mixtures thereof; preferably poly(N-vinyl pyrrolidone). Alternatively, the vinyl lactam polymer is a copolymer of N-vinyl pyrrolidone and butane; a copolymer of N-vinyl pyrrolidone and a C₁₄ to C₂₄ alpha olefin; a copolymer of N-vinyl pyrrolidone and vinyl acetate, or a copolymer of N-vinyl pyrrolidone, dimethylaminoethylmethacrylate and N-vinyl caprolactam.

A typical anionic polymeric dispersing agent herein is a partially neutralized lower alkyl vinyl ether/maleic acid half ester copolymer; e.g. a sodium salt of alkyl vinyl ether/maleic acid half ester copolymer; a sulfonated naphthalene formaldehyde condensate, a lignosulfonate, or a metal salt thereof, a polyacrylate copolymer; α-olefin and maleic acid/salt copolymer, or a polystyrene/maleic acid copolymer.

The invention also includes a mixture of the solid dispersant composition and a water-insoluble active ingredient, preferably an agriculturally active ingredient; a dye or a polymer, e.g. wax or rubber.

The invention may take the form of a wettable powder which includes the solid dispersant composition described above, a water-insoluble active ingredient and a wetting agent, optionally with a defoamer, a thickening agent, or a filler, or mixtures thereof; or a water dispersible granule which is an agglomerated solid of the wettable powder; or a tablet which comprises a compressed water dispersible granule.

### DETAILED DESCRIPTION OF THE INVENTION

The primary dispersant in the present solid polymeric dispersant composition is an anionic polymeric dispersant such as the sodium salt of alkyl vinyl ether/maleic acid half-ester copolymer (Easy-Sperse®) (ISP), a lignosulfonate or metal salt thereof, e.g. POLYFON® or REAX®, (Westvaco); a sulfonated naphthalene/formaldehyde condensate, e.g. MORWET®, (Witco); UFOXANE® or MARESPERSE®, (Lignotech); a polyacrylate such as methacrylate/ethylacrylate acrylate copolymer; an alpha-olefin/maleic acid copolymer, or any other polymeric anionic dispersant capable of dispersing hydrophobic compounds in water. Desirably the monomer of the anionic polymer contains 1-4 anionic sites per mole of repeat units.

The co-dispersant in the composition of the invention is a vinyl lactam which can be the homopolymer of vinyl caprolactam or vinyl pyrrolidone either optionally substituted on the ring or in the vinyl group with lower alkyl (C₁ to C₄ alkyl) or a mixture of these homopolymers. Alternatively the co-dispersant can be a copolymer of vinyl caprolactam and/or vinyl pyrrolidone, e.g. vinyl caprolactam/vinyl pyrrolidone copolymer, vinyl pyrrolidone/vinyl acetate, vinyl methylpyrrolidone/vinyl acetate, methylvinyl pyrrolidone/acrylic acid, a copolymer of butane; or vinyl pyrrolidone and a copolymer of vinyl pyrrolidone and a C₁₄-C₂₄ alpha-olefin. The vinyl lactam co-dispersant generally have a weight average molecular weight of between about 5,000 and about 100,000 consistent with a Fikentscher K-value of from about 10 to about 120. In the solid dispersant mixture, the lactam polymer can coil around and coat at least a portion of an active water-insoluble ingredient thus reducing its surface hydrophobicity while retaining the intrinsic hydrophobic character of the insoluble active component. The lactam coating also can associate with anions of the primary dispersant to provide a composition of improved stability and permit high load active compositions for disparate hydrophobic species which are not otherwise suspendable.

The active component of the invention compositions is a particulate, substantially water-insoluble compound, or a hydrophobic mixture of such compounds and is preferably an active animal fumigant or agricultural chemical including nematocides, fungicides, insecticides, herbicides and mulliscides as well as agricultural fertilizers, nutrients, plant growth accelerants or growth controlling agents or any other hydrophobic chemical having properties which are suitable for agricultural uses in terms of application to plants or domestic household or animal uses for controlling insects and pests. Particularly, such chemicals would normally take the form of water-immiscible or oily liquids and/or solids which are substantially insoluble in water. By the term “substantially insoluble”, it is meant that for all practical purposes, the solubility of the compound in water is insufficient to make the compound practicably usable in a spray-on or dip end use without some modification either to increase its solubility or dispersability in water, so as to increase the compound's bioavailability or avoid the use of excessively large volumes of solvent.

Suitable agriculturally active chemicals which can be used with the present invention include insecticides, such as, cyclocompounds, carbamates, animal and plant derivatives, synthetic pyrethroids, diphenyl compounds, non-phosphates, organic phosphates, thiophosphates, and dithiosphosphates. (See Agricultural Chemicals, Book I, Insecticides, 1989 Revision by W. T. Thomson, Thomson Publications.) Typical of the insecticides are:

| | |
|---|---|
| Cyclocompounds: | 6,7,8,9,10,10-hexachloro- |
| | 1,5,5a,6,9,9a-hexahydro-6,9- |
| | methano-2,4,3-benzodioxathiepin-3-oxide |
| Carbamates: | 2-isopropyl phenyl-N-methyl carbamate; |
| | 2-(1,3-dioxolan-2-yl)phenylmethyl carbamate; |
| | 2,3-isopropylidine dioxyphenyl methyl carbamate; |
| Animal and Plant | chlorinated hydrocarbons derived from Southern |
| Derivatives | pine naturally occurring lactone glycoside; |
| Synthetic Pyrethroids: | (±) α-cyano-3-phenoxybenzyl (±) cis, trans |
| | 3-(2,2-dichlorovinyl)-2,2-dimethyl cyclopropane |
| | carboxylate; |
| | (±) cyano (3-phenoxyphenyl) methyl (±)-4- |
| | (difluoromethoxy) α-(1-methylethyl) benzene |
| | acetate; |
| Phenoxy Compounds | 2,2-bis(p-methoxy phenyl)- |
| and Non-Phosphate: | 1,1,1,trichloroethane; |
| | 1,3,5,tri-n-propyl-1,3,5-triazine- |
| | 2,4,6 (1H,3H,5H) trione; |
| | ethyl (2E, 4E)-3,7,11-trimethyl- |
| | 2,4-dodeca dienoate; |
| | 1-decycloxy 4-[(7-oxa-oct-4-ynyl)]-oxybenzene; |
| Organic Phosphates: | dimethyl phosphate ester of 3-hydroxy-N,N- |
| | dimethyl-cis-crotonamide; |
| | 2-chloro-1-(2,4-dichloro phenyl) vinyl |
| | diethylphosphate; |
| | 4-(methyl thio) phenyl dipropyl phosphate; |
| Thiophosphates: | 0,0-diethyl-0-4-nitrophenyl phosphorothioate; |
| | 0,0-diethyl-0- |
| | (2,isopropyl-6-methyl-5-pyrimidinyl) |
| | phosphorothioate; |
| | 2-diethylamino-6-methyl |
| | pyrimidine-4-yl dimethyl |
| | phosphorothioate; |
| Dithiophosphates: | 0,0-dimethyl phosphorodithioate ester of |
| | diethylmercapto succinate; |
| | 0-ethyl-S-phenyl ethyl phosphorodithioate. |

Typical herbicides include phenoxy compounds, benzoic, acetic, and phthalic acids, aniline derivatives, nitriles, amides, acetamides, anilides, carbamates, thiocarbamates, and heterocyclic nitrogen derivatives, e.g., triazines, pyridines, pyridazones, picolinic acid, and urea derivates and phosphates. (See Agricultural Chemicals. Book II, Herbicides. 1986-87 Edition, W. T. Thomson, Thomson Publications, Fresno, Calif. 93791.) Exemplary of the above compounds are:

| | |
|---|---|
| Phenoxy Compounds: | 2,4-dichlorophenoxy acetic acid |
| | 2,4,5-trichloro phenoxyacetic acid; |
| | 4-(2,4-dichlorophenoxy) butyric acid; |
| | S-ethyl 2 methyl-4-chlorophenoxythioacetate; |
| | 2-methyl-4-chloro-phenoxy acetic acid; |
| | methyl 5-(2,4-dichloro-phenoxy-2-nitrobenzoate; |
| Benzoic and Acetic | 3,6-dichloro-o-anisic acid 4-chloro-2-oxo |
| Acids of Phthalic | benzothiazolin-3-yl acetic acid; |
| Compounds: | N-1-Naphthyl-phthalamic acid; |
| Nitriles and Aniline | 3-5-dibromo-4-hydroxybenzo-nitrile; |
| Derivatives: | α,α,α,trifluoro-2,6-dinitro- |
| | N,N-dipropyl-p-tolinidine; |
| | N-(1-ethylpropyl)-2,6-dinitro-3,4-xylidine; |
| Amides, Acetamides, | N,N-diethyl-2- |
| Anilides: | (1-naphthalenyl oxy)-propionamide; |
| | 2,6-dimethyl-N-2′ |
| | methoxyethyl-chloro-acetanilide; |
| | 3′,4′-dichloro-propionanilide; |
| | α-chloracetic-N-(3,5,5-trimethylcyclohexen-1-yl)- |
| | N-isopropylamide; |
| | 4-benzyl-N-isopropyl trimethyl acetamide; |
| Thiocarbamates: | S-ethyl dipropyl thiocarbamate; |
| Urea Derivatives: | 3-(5-tert-butyl-3-isoxazoyl)-1,1-dimethyl urea; |
| | N-(2,6-trifluoro-benzoyl)-N′-[2,5-dichloro-4- |
| | (1,1,2,3,3,3-hexafluoropropyloxy)phenyl] urea; |
| Pyrrolidone | 1-(m-trifluoro methyl pheny1)-3-chloro-4- |
| Derivatives: | chloromethyl-2-pyrrolidone; |
| Amino Acid | methyl N-benzoyl-N-(3-chloro-4-fluorophenyl)- |
| Derivatives: | DL alarinate; |
| | N-chloroacetyl-N-(2,6-diethylphenyl)-glycine |
| | ethyl ester; |
| Carbamates: | Isopropyl-m-chlorocarbanilate; |
| | 3-ethoxy (carbonyl aminophenyl)-N-phenyl |
| | carbamate; |
| Heterocyclics: | 4-amino-3,5-dichloro-6-fluoro-2-pyridyloxy |
| | acetic acid; |
| | 4-(1,2-Dimethyl-N-propyl amino)-2-ethyl amino- |
| | 6-methyl thio-S-triazine; |
| | 2-[4,5-dihydro |
| | 4-methyl-4-(1-methylethyl)-5-oxo-1 |
| | H-imidazoyl-2yl-3-byridinecarboxylic acid; |
| | 2-[3,5-dichlorophenyl)-2-(2,2,2-trichloroethyl) |
| | oxinane; |
| | butyl-9-hydro-fluorene-(9)-carboxylate; |
| | 2-[1-(ethoxy imino) butyl]-3-hydroxy-5-(2H-tetra |
| | hydro thiopyran-3-yl)-2-cyclohexene-ione; |
| | 2-(2 chlorophenyl) methy1-4,4-dimethyl-3-iso |
| | oxazolidinone; |
| Phosphates: | 0-ethy1-0-(3-methyl-6-nitro phenyl) N-sec-butyl |
| | phosphoro thio amidate. |

Typical fungicides include (See Agricultural Chemicals, Book IV, Fungicides. 1989 Revision, W. T. Thomson, Thomson Publications, Fresno, Calif. 93791):

| | |
|---|---|
| Organic Compounds: | 2,5-dimethyl-N-Cyclohexyl-N-methoxy-3-furan |
| | carboxamide; |
| | 5-Ethyoxy-3-trichloromethyl-1,2,4-thiadiazole; |
| | 3-(2-methyl piperidino) propyl |
| | 3,4-dichlorobenzoate; |
| | N,N′-(1,4-piperazinediyl bis (2,2,2-trichloro) |
| | ethylidene) bis formamide; |
| | Tetramethyl thiuram disulfide; |
| | 0-Ethyl-S,S,diphenyl-dithiophosphate; |
| | 5,10-dihydro-5,10-dioxo naphtho |
| | (2,3,9)-p-dithiin- |
| | 2,3-dicarbonitrile; |
| | 2-(Thiocyano methyl thio) benzothiazole; |
| | α-2-(4-chlorophenyl) ethyl]- |
| | α-(1,1-dimethyl ethyl)-1 |
| | H-1,2,4-triazole-1-ethanol; |
| | Iodopropargyl butyl carbonate; |
| | Tetra chloro iso phthalonitrile |
| Morpholines: | N-tridecyl-2,6-dimethyl morpholine; |
| | 4-N-dodecyl-2,6-dimethyl morpholine |

Typical fumigants, growth regulators, repellants, and rodenticides include (See Agricultural Chemicals, Book III, Fumigants, 1988-1989 Revision, W. T. Thomson, Thomson Publications, Fresno, Calif. 93791):

| | |
|---|---|
| Growth Regulants: | 1,2 Dihydro-6-ethyoxy-2,2,4-trimethylquinoline; |
| | (2-chloroethyl) phosphoric acid; |
| | 4-[acetamino methyl]-2-chloro-N-(2,6-diethyl |
| | phenyl acetamide; |
| | Benzoic acid, 3,6 dichloro-2-methoxy,2-ethoxy-1- |
| | methyl-2-oxo ethyl ester; |
| Repellants: | 0,0-dimethyl-0-[(4-methyl thio)-m-tolyl] |
| | phosphorothioate; |
| | Tertiary butyl-sulfenyl dimethyl dithio carbamate; |
| Seed Softener: | 2-chloro-6-(trichloromethyl) pyridine; |
| | 5-ethoxy-3-trichloromethyl-1,2,4-thiadiazole; |
| | N-phenyl-N′-1,2,3-thiadiazol-5-yl urea. |

Pesticides may be characterized by their physical properties, depending on their physical state at normal or ambient conditions, i.e., between 40° F. and 90° F. and their solubility or miscibility with water or other common organic solvents, e.g., aromatics, such as, toluene, xylene, methylated and polyalkylated naphthalenes, and aliphatic solvents.

Based on the physical properties, the pesticides may be classified into two groups. The first group includes those which are oily liquids at ambient temperatures and are immiscible with water. Specific pesticides include:
Common esters of 2,4-dichlorophenoxyacetic acid,
Common esters of 2,4,5-trichlorophenoxyacetic acid,
Common esters of 2-(2,4-dichlorophenoxy) propionic acid,
Common esters of 2-(2,4,5-trichlorophenozy) propionic acid,
Common esters of 2,4-dichlorobutyric acid,
Common esters of 2,methoxy-3,6-dichlorobenzoic acid,
Common esters of 2-methyl-4-chlorophenoxyacetic acid,
Piperonyl butoxide 3,4-methylenedioxy-6-propyl benzyl n-butyl diethylene glycol ether,
Bromophos ethyl: 0,0-diethyl-0-2,5-dichloro-4-bromophenyl thionophosphate,
N-(2-mercaptoethyl) benzene-sulfenamide (BETASAN®),
Isobomyl Thiocyanoacetate (Thanite®),
loxynil ester of octanoic acid,
Molinate S-ethyl hexahydro-1H-azepine-1-carbothioate,
PP 511 O,O-dimethyl-(2-diethylamine 4-methyl-6-pyrimidinyl) carbamate,
PP 211 O,O-diethyl O-(2-diethylamine-4-methyl-6-pyrimidinyl) phosphorocarbamate,
Chlordane,
5-Ethoxy-3-(trichloromethyl)-1,2,4-thiadiazole (TERRAZALE®),
Ethyl-s-s-dipropyl-phosphodithioate (MOCAP®),
S-Ethyl dipropylthiocarbamate (EPTAM®),
S-Ethyl diisobutylthiocarbamate (SUTAN®),
S-n. propyl-di-n-propylthiocarbamate (VERNAM®),
S-propyl butylethylthiocarbamate (TILLAM®),
S-ethyl ethylcyclohexylthiocarbamate (RO-NEET®),
Malathion (S-(1,2-dicarboxyethyl)-O,O-dimethyl phosphorodithioate),
Diazinon (O,O-diethyl,O-(2-isopropyl-4-methyl-6-pyrimidinyl) phosphorothioate,
O-Ethyl-S-phenyl-ethylphosphonodithioate (DYFONATE®),
Toxaphene (Octachlorocamphene),
Bromoxynil (3,5-dibromo-4-hydroxy benzonitrile ester of n.octanoic acid,
2-chloro-N-2,6-diethylphenyl-N-methoxymethylacetamide (LASSO®),
Diallate S-2,3-dichloroallyl N,N-diisopropylthiolcarbamate,
Triallate S-2,33-trichloroallyl N,N-diisopropylthiolcarbamate.

The second group comprises those pesticides which are solids at ambient temperatures and for all practical purposes, insoluble in water.
2,4,5-T (2,4,5-trichlorophenoxy acetic acid)
Monuron (3-(p-chlorophenyl)-1,1-dimethyl urea)
Diuron (3-(3,4-dichlorophenyl)-1,1-dimethyl urea)
Bromacil (5 bromo-3-sec. butyl-6-methyl uracil)
Isocil (5 bromo-3-isopropyl-6-methyl uracil)
Linuron (3-(3,4 dlchlorophenyl)-1-methoxy-1 methyl urea
Atrazine (2-chloro-4-ethylamino-6 isopropylamino-s-triazine) Simazine (2-chloro-4,6,-bis (ethylamino)-s-triazine
Dodine (n-dodecylguanidine acetate)
Thiram (tetramethylthiuram disulfide)
N-(mercaptomethyl)phthalimide s-(o,o dimethylphosphoro-dithioate) (IMIDAN®)
Lindane (gamma 1,2,3,4,5,6 hexachlorocyclohexane)
Folpet (N-trichloromethylphthalimide)
Manazon (s-(4,6-diamino-1,3,5-triazin-2-yl methyl)-dimethylphosphorothiolthionate)
Barban (4-chloro-2 butynyl m-chlorocarbanilate)
Tricumba 2-methoxy-3,5,6-trichlorobenzoic acid
Trifluralin (2,6-dinitro-N,N-dipropyl-4-trifluoromethylamiline) (2,3 dihydro-5-carboxanilido-6-methyl-1,4-oxathiin) (VITAVAX®)
2,4-dichlorophenoxyacetic acid
4-(4-chloro-2 methylphenoxy) butyric acid
2-(2,4-dichlorophenoxy) propionic acid
loxynil: 3,5 diiodo-4-hydroxybenzonitrile
Bromoxyni1: 3,5 dibromo-4-hydroxybenzonitrile
Carbaryl: 1-naphthyl-N-methylcarbamate
Methoxychlor: 2,2,-Bis(p-methoxyphenyl)-1,1-trichloro-ethane
PP 781: 4(2-chloro phenylhydrazono)-3-methyl-5-isoxazolone*
PP 675: 5-butyl-2-dimethylamino-4-hydroxy-6-methyl pyrimidine*
PP 062: 5,6-dimethyl-2-dimethylamino-4 pyrimidinyl dimethylcarbamate*
PP 149: 5-n-butyl-2 ethylamino-4-hydroxy-6 methylpyrimidine*
   * Manufactured by Imperial Chemical Industries Limited
C 6313 N′-(4-bromo-3-chlorophenyl)-N-methoxy-N-methylurea
C 6989 2,4′dinitro-4-trifluoromethyl-diphenylether
Chloroxuron N′-4-(chlorophenoxy) phenyl-NN-dimethylurea
Dichlobenil 2,6-dichlorobenzonitrile
Diphenamid NN-dimethyl-2,2-diphenylacetamide
Fenac 2,3,6-trichlorophenylacetic acid
Fluometuron N′-(3-trifluoromethylphenyl)-NN-dimethylurea
GS 14260 4-ethylamino-2-methylthio-6-t-butyl-amino-1,3,5-triazine
PCP Pentachlorophenol
Lenacil 3-cyclohexyl-6,7-dihydro-1H-cyclo-pentapyrimidine-2,4-(3H,5H)-dione
Pyrazon 5-amino-4-chloro-2-phenyl-3-pyridazone
Metrobromuron N′-(4-bromophenyl)N-methoxy-N-methylurea
Metoxymarc N-(4-methoxybenzoyl)-N-(3,4-dichlorophenyl)-N′, N′-dimethylurea
Neburon N-butyl-N′-(3,4-dichlorophenyl-N-methylurea
NIA 11092 1,1-dimethyl-3-[3-(n-t-butyl carbamyloxy) phenyl] urea
Mecoprop 2-(4-chloro-2 methylphenoxy)propionic acid
Monolinuron N′-(4-chlorophenyl)-N-methoxy-N-methylurea
Nitrofen 2,4-dichlorphenyl 4-nitrophenylether
Propanil N-(3,4-dichlorophenyl)propionamide
Pyriclor 2,3,5-trichloro-4-pyridinol
Solan 3′-chloro-2-methyl-p-volerotoluidide
Terbacil 5-chloro-3-t-butyl-6-methyluracil
UC 22463 (SIRMATE)-3,4-dlchlorobenzyl N-methylcarbamate
WL 9385 2-Azido-4-ethylamino-6-t-butylamino-s-triazine
Propachlor 2-chloro-N-isopropylacetanilide
CP 50144 2-chloro-N-2,6-diethylphenyl-N-methoxymethyl acetamide
CP 31675 2-chloro-N-(2 methyl-6-t-butylphenyl) acetamide
Cypromid 3′,4′-dichlorocyclopropane carboxanilide
Fenuron NN-dimethyl-N′phenylurea
Chlorbromuron N′-(4-bromo-3-chlorophenyl)-N-methoxy-N-methyl urea
Ametryne 2-methylmercapto-4-ethylamino-6-isopropyl-amino-s-triazine
Prometryne 2-methylmercapto-4,6-bisisopropyl amino-s-triazine
DCPA dimethyl 2,3,5,6, tetrachloroterephthalate
Benefin N-butyl-N-ethyl-2,2,2-trifluoro-2,6-dinitro-p-toluidine
Nitralin 2,6-dinitro-4-methylsulfonyl-NN-dipropyl-aniline
PP 493 2,6-difluoro-3,5-dichloro-4-hydroxy pyridine
CNP 2,4,6-trichlorophenyl-4′-nitrophenyl ether
Pentachloro nitrobenzene
1-(butile carbamoyl)-2-benzimidazol carbamic acid, methyl ester (BENLATE®).

Suitably, dyes and polymers may be used as the active ingredient.

In a typical run, the commercial product Easy-Sperse® (International Specialty Products) is employed as the primary anionic polymeric dispersant in the solid composition of the invention. Easy-Sperse® is the partially neutralized (NaOH) aqueous solution of methyl vinyl ether/maleic acid half-ester copolymer having a solids content of about 25% and a viscosity of about 6,000 cps. The co-dispersant is an aqueous solution of polyvinyl pyrrolidone (20-40% solids).

First a solution/slurry of both primary and co-dispersants is provided in the weight ratio in these ingredients of 0.1:1 to 1:0.1, respectively, preferably 1:0.5 to 1:5, and, most preferably, 1:1 to 1:4. The solution/slurry may be diluted with water, if necessary, to produce a viscosity particularly suitable for spray drying, e.g. 3,000 to 6,000 cps. Then the solution/slurry is spray dried suitably at an inlet temperature of about 300-480° F. and an outlet temperature of about 150-270° F. The product of the spray drying process is a solid polymeric dispersant composition suitable for delivery of water-insoluble actives. If, however, both the primary and co-dispersants are commercially available as solids, then only simple granulation of the ingredients may be required to obtain the desired solid composition.

The active material then can be added in suitable amounts and processed, if desired, under anhydrous conditions, for water-sensitive actives, and made into solid delivery systems such as wettable powders, water dispersible granules and tablets.

If desired, the solid form can be used in an aqueous medium with water of dilution, in an aqueous or suspension formulation.

If desired, the formulation can be coated onto hydrophobic surfaces, or printed onto sheets.

The products of the invention are advantageous from a commercial standpoint because they require less anionic dispersants, exhibit better binding in the solid form for granules and tablets and are particularly rainfast.

The compositions of the invention can optionally contain other inert components such as an anti-freezing agent, e.g. propylene glycol, in cases where the mixture is to be stored at or below freezing temperatures; a defoaming agent, e.g. a silicon oil such as RHODORSIL® Antifoam 426R, (Rhodia), a thickening agent e.g. a carbohydrate polysaccharide such as KELZAN®, (Kelco), and/or other conventional additives employed for color, odor or taste or other optional effect.

The use of the co-dispersant lactam polymer in the present solid mixture permits the use of a lower concentration of the primary anionic polymeric dispersant component which reduces irritant properties and/or foaming. Also the presence of the lactam polymer in the solid mixture allows the use of several otherwise incompatible anionic polymeric dispersants.

The solid composition of the invention is efficiently prepared by simply homogenizing and wet-milling the components or by extrusion. The above composition may be diluted with the desired amount of water by mixing in a high speed mixer for a period of from about 30 minutes to 1 hour.

The composition of the present invention can incorporate up to 90% of the active material in its mixture while retaining its stability for at least 1 year or more. On dilution the active component can have a concentration of 10 ppm to 5% in the diluted mixture while retaining stability of 4 hours or more. The combination of the anionic dispersant with the lactam polymer has a synergistic suspension effect in that the dispersing ability of the sum of either component alone is markedly exceeded.

Having generally described the invention, reference is had to the following examples which illustrate preferred embodiments and comparisons of the present concentrate or formulation with those of the prior art.

### EXAMPLE 1

### Preparation of Solid Polymeric Dispersant Composition of Invention

72 g of an Easy-Sperse® solution (24.8% solids) was mixed with 176 g of PVP K-30 (30.5% solids), homogenized at room temperature for 1 hour and concentrated in a hood overnight at room temperature followed by drying in a vacuum oven (<10 mm Hg) at 80° C. for 2 hours. The resulting solid product had a Tg of 159° C. and <1% bound water and a wt. ratio of Easy-Sperse® to PVP of 1:3.

### EXAMPLE 2

### Preparation of Solid Polymeric Dispersant Composition by Spray Drying

240 Kg of Easy-Sperse® solution (26% solids) and 720 Kg of PVP K-30 (36.6% solids) were mixed and heated to 120° F. and diluted with 600 lbs of water. The resulting solution was fed into a commercial spray dryer with an inlet temperature of 410° F. and an outlet temperature of 265° F. A solid was obtained in the form of a powder which passed through a 20 mesh screen. 700 lbs of dry material was obtained with 7% bound water. The wt. ratio of Easy-Sperse® to PVP was 1:4.

### EXAMPLE 3

Examples 1 and 2 were repeated at a wt ratio of 1:1. Similar results were obtained.

### EXAMPLE 4

Examples 1 and 2 were repeated at a wt. ratio of 1:2. Similar results were obtained.

### EXAMPLE 5

Example 1 was repeated with solid Morwet® D425 in place of a solution of Easy-Sperse®, and a solution of PVP to produce a 1:1 wt. ratio solid.

### EXAMPLE 6

Example 5 was repeated at a wt. ratio of 1:3 with similar results.

### EXAMPLE 7

Example 5 was repeated with solid Reax® 100M in place of Morwet® D-425 with similar results.

### EXAMPLE 8

Example 6 was repeated with solid Reax® 100M in place of Morwet® D-425 with similar results.

### EXAMPLE 9

### Mixture of Solid Dispersant and Active

900 g of commercial Atrazine® active was mixed with 100 g of the polymeric dispersant of Example 2 in a V-blender. This solid premix was used to formulate wettable powders, suspension concentrates, water-dispersible granules and tablets of the active.

### EXAMPLE 10

### Wettable Powders

50 g of the solid composition of Example 6 was mixed with 800 g sulfur as active, 50 g Reax® 88B, 20 g Morwet® EFW (wetting agent) and 10 g soda soap (defoamer). The mixture was blended in a V blender. The resulting wettable powder product produced had a dispersibility >80%.

### EXAMPLE 11

### Water Dispersible Granules (WDG)

500 g of the preblend of Example 9 was mixed with 10 g defoamer (soda soap), 10 g Morwet EFW (wetting agent) and 10 g cross linked PVP (Agrimer® AT) (disintegrant). The charge was loaded in a 24-inch dia pan granulator operating at medium speed of rotation. Water was added in fine jet at the rate of 3 g per minute for a period of 20 minutes. The wet granulated product was collected and wet sieved between 40 mesh 30 mesh screen. The product was dried in a laboratory oven. The resulting WDG had excellent dispersion (>80%) and friability (<10%) properties.

### EXAMPLE 12

700 g commercial chlorothalonil (Nuiocide® 960) powder was mixed with 150 g Agrimax 3H (commercial blend for granulation, containing N-octyl pyrrolidone, solvent, surfactant and alkylated polyvinyl pyrrolidone copolymer), 80 g polymeric dispersant of Example 2 and 10 g Agrimer ATF (disintegrant) in a planetary mixture to produce a paste. The paste was extruded within 2 hours in a laboratory bench top extruder at a maximum speed through a screen having openings of 0.5-1.0 mm. The extruded granules were dried in an air oven for a period of 2 hours at a temperature of 50-60° C. The resulting dry extruded WDG showed excellent dispersibility of >90%, and friability of <10%.

### EXAMPLE 13

30 g of commercial cypermethrin was mixed with 70 g of the polymeric dispersant/binder composition of Example 6. This mixture was fed in a twin barrel thermal extruder with its hot end maintained at a temperature of 120° C. and its cold end at 35° C. The extruded granules had good hardness and dispersibility.

### EXAMPLE 14

The composition shown in Example 10 was charged in a fluid bed granulator and spray dried. Dispersibility of the granules were >80%.

### EXAMPLE 15

Following charge was used in a laboratory dry compactor. 100 g of Metsulfuron methyl®; 2 g of the solid polymeric dispersant of Example 7 and 4 g of polymeric dispersant of Example 2; 2 g Agrimer ATF 2 g, Stabaxol I (desiccant), 4 g CMC, and Bentonite (filler) to a charge of 500 g. The dry compacted product was broken down into granules and separated to fractions between 40 and 30 mesh. The granules showed good hardness and dispersibility.

### EXAMPLE 16

The product of Example 15 was compressed into a tablet using a laboratory press at a pressure of about 100 psi. The tablet showed acceptable friability, hardness and dispersibility.

### EXAMPLE 17

A stable suspension of Acid green 25 was made with 20% loading using the polymeric dispersant of Example 5. The suspension was stable with initial viscosity less than 1000 cps and there was no appreciable change in viscosity on standing for 4 weeks.

### EXAMPLE 18

A stable suspension of 20% bees wax was made by mixing in a high sheer blender 76-78 g water containing 2-4 g polymeric dispersant of Examples 5 or 6 and adding 20 g molten wax. The suspension was shear stable.

### EXAMPLE 19

A stable suspension of 20% polyisobutene was made by mixing in a high sheer blender 76-78 g water containing 2-4 g polymeric dispersant of Example 3, and adding 20 g polyisobutene at temperature ˜50° C. Additionally, 0.1% Keizan (thickener) and 3% propylene glycol (anti-freeze), and 0.2% Rhodorsil Antifoam 426R (defoamer), 0.2% Proxell (preservative) were added. The suspension was stable with no separation for a week. After long storage (>30 days) resuspension was complete in less than 20 inversions.

### EXAMPLE 20

A water-based suspension of commercial SBR, polystyrene butadiene rubber, was made as follows:

A solution containing 15% SBR was made in toluene by dissolving 15 g SBR in 85 g toluene at room temperature. To 50 g of the above solution taken in a high hear blender, 50 g of water containing 2 g of polymeric dispersant of Example 3 was added under high shear. The mixture was stirred at high shear for 10 minutes. The toluene/water azeotrope was removed by rotary evaporation with periodic replacement with water. The resulting aqueous suspension contained less than 1% toluene and about 8% SBR.

### EXAMPLE 21

The precharge mixture of Example 9 was used to prepare a suspension concentrate with 45% of the solid of Example 9, 0.2% defoamer, 0.2% of preservative, and 0.1% thickener and water, with a Media-mill. The resulting suspension after dilution at 1:100 was 80% suspendability and excellent rainfastness.

While the invention has been described with particular reference to certain embodiments thereof, it will be understood that changes and modifications may be made which are within the skill of the art. Accordingly, it is intended to be bound only by the following claims, in which:

What is claimed is:

1. A solid polymeric dispersant composition comprising one or more anionic polymeric dispersant agents and a co-dispersant which is a homopolymer and/or a copolymer of a heterocyclic vinyl lactam containing 4 to 6 ring carbon atoms; which heterocyclic polymer is optionally substituted on the ring or in the vinyl moiety with lower alkyl, in a wt. ratio of 0.1:1 to 1:0.1, respectively.

2. A solid polymeric dispersant composition according to claim 1 wherein said wt. ratio is 1:0.5 to 1:5.

3. A solid polymeric dispersant composition according to claim 1 wherein said wt. ratio is 1:1 to 1:4.

4. A solid polymeric dispersant composition of claim 1 wherein said vinyl lactam polymer is selected from the group consisting of homo- and co- polymers of N-vinyl pyrrolidone and N-vinyl caprolactam, and mixtures thereof.

5. A solid polymeric dispersant composition of claim 4 wherein said vinyl lactam polymer is poly(N-vinyl pyrrolidone).

6. A solid polymeric dispersant composition of claim 1 wherein said vinyl lactam polymer is a copolymer of N-vinyl pyrrolidone and butane, a copolymer of N-vinyl pyrrolidone and a C₁₄ to C₂₄ alpha olefin, a copolymer of N-vinyl pyrrolidone and vinyl acetate, or a copolymer of N-vinyl pyrrolidone, dimethylaminoethylmethacrylate and N-vinyl caprolactam.

7. A solid polymeric dispersant composition of claim 1 wherein said anionic polymeric dispersing agent is a partially neutralized lower alkyl vinyl ether/maleic acid half ester copolymer.

8. A solid polymeric dispersant composition of claim 1 wherein said anionic polymeric dispersing agent is the sodium salt of alkyl vinyl ether/maleic acid half ester copolymer.

9. A solid polymeric dispersant composition of claim 1 wherein said anionic polymeric dispersing agent is a sulfonated naphthalene formaldehyde condensate, a lignosulfonate, or a metal salt thereof, a polyacrylate copolymer, an α-olefin maleic acid/salt copolymer, or a polystyrene maleic acid copolymer.

10. A mixture of the solid dispersant composition of claim 1 and a substantially water-insoluble active ingredient.

11. A mixture according to claim 10 wherein said active is an agriculturally active ingredient.

12. A wettable powder which includes the solid dispersant composition of claim 1, a water-insoluble active ingredient and a wetting agent, optionally with a defoamer, a thickening agent, or a filler, or mixtures thereof.

13. A water dispersible granule comprising an agglomerated solid of composition of claim 1, a water-insoluble active ingredient and, optionally, a defoamer, a thickening agent, a filler or binder, or mixtures thereof.

14. A tablet comprising a compressed water dispersible granule of claim 13.
